(19) United States
(12) Patent Application Publication
(10) Pub. No.: US 2008/0061150 A1
(43) Pub. Date: Mar. 13, 2008

(54) IDENTIFICATION TOKEN AND METHOD OF MAKING IDENTIFICATION TOKEN

(76) Inventor: Simon Phillips, York (GB)

Correspondence Address: BUCKLEY, MASCHOFF & TALWALKAR LLC, 50 LOCUST AVENUE, NEW CANAAN, CT, 06840, US

(21) Appl. No.: 11/852,739

(22) Filed: Sep. 10, 2007

Related U.S. Application Data
(60) Provisional application No. 60/843,044, filed on Sep. 8, 2006.

(51) Int. Cl. G06K 19/06; G06Q 40/00

(52) U.S. Cl. 235/492; 705/41

(57) ABSTRACT

In accordance with some embodiments, a method includes providing an integrated circuit (IC) card having a first size and carried as part of a surrounding card having a second size larger than the first size, the IC card including an IC, the surrounding card including an antenna coupled to the IC; and transmitting to the IC via the antenna an account number for storage in the IC, the account number to be accessed with use of the IC card. In accordance with some embodiments, an identification token includes a carrier having a body; a card including an RFID integrated circuit; a bridge joining the card to the carrier; an antenna; and an electrically conductive connection running along the bridge, the electrically conductive connection coupling the RFID IC to the antenna. In accordance with some embodiments, a method includes providing a carrier having a body; providing a card including an RFID integrated circuit; providing a bridge joining the card to the carrier; and providing an antenna and an electrically conductive connection running along the bridge, the electrically conductive connection coupling the RFID IC to the antenna. In accordance with some embodiments, a method includes: providing an integrated circuit (IC) card attached to a surrounding card, the IC card including an IC, the surrounding card including an antenna coupled to the IC; and transmitting to the IC via the antenna information for storage in the IC, the information to be accessed with use of the IC card after the IC card is detached from the surrounding card.

### CROSS REFERENCE TO RELATED APPLICATION

This application claims priority under 35 U.S.C. § 119 to U.S. Provisional Patent Application Ser. No. 60/843,044, entitled “METHOD OF MAKING PROXIMITY PAYMENT DEVICE”, filed in the name of Simon Phillips on Sep. 8, 2006, the contents of which are hereby incorporated by reference.

### BACKGROUND

Proximity payment cards are in widespread use. A well known standard for such cards has been promulgated by MasterCard International Incorporated, the assignee hereof, and is referred to as “PayPass”. Proximity payment cards typically include a radio frequency identification (RFID) integrated circuit (IC) embedded in a card-shaped plastic body. An antenna is also embedded in the card body. The antenna allows the card to receive a power signal from a point of sale terminal. The antenna is also used by the RFID IC to transmit the payment card account number, and possibly other information as well, to the POS terminal.

The present inventor now proposes, among other things, an improved technique for making proximity payment devices.

### BRIEF DESCRIPTION OF THE DRAWINGS

FIG. 1 is a flow chart that illustrates a process for making a proximity payment device according to some embodiments.

FIG. 2A is a plan view of a structure that includes a small IC card blank and a larger carrier for the small IC card blank, in accordance with some embodiments.

FIG. 2B is a perspective view of the structure of FIG. 2A as the small IC card is being detached from the carrier.

FIG. 3 is a view similar to FIG. 2A of the carrier after the small IC card has been removed therefrom.

FIG. 4 is a plan view of the small IC card after it has been removed from the carrier.

FIG. 5A is a schematic plan view of a proximity payment device in which the small IC card has been incorporated.

FIG. 5B is a schematic plan view of a portion of the proximity payment device of FIG. 5A, in accordance with some embodiments, prior to installing the small IC card therein.

FIGS. 6A-6D show a method for fabricating the card blank and carrier of FIG. 2A, in accordance with some embodiments.

FIGS. 7A-7B are perspective views of a proximity payment device, according to some embodiments.

FIG. 7C is a perspective view of a portion of the proximity payment device of FIGS. 7A-7B, according to some embodiments, with a case in an open state.

FIG. 7D is a partially exploded perspective view of the proximity payment device of FIGS. 7A-7B, according to some embodiments, with the case in an open state and the small IC card uninstalled.

FIG. 7E is a schematic plan view of a portion of the proximity payment device of FIGS. 7A-7B, according to some embodiments, with the case removed and the small IC card uninstalled.

FIG. 7F is a schematic plan view of a portion of the proximity payment device of FIGS. 7A-7B, according to some embodiments, with a case removed and the small IC card uninstalled.

FIG. 7G is a schematic plan view of a portion of the proximity payment device of FIGS. 7A-7B, according to some embodiments, with a case removed and the small IC card uninstalled.

FIG. 8A is a schematic plan view of a portion of a proximity payment device, according to some embodiments, with the case removed and the small IC card uninstalled.

FIG. 8B is a schematic plan view of a portion of a proximity payment device, according to some embodiments, with the case removed and the small IC card uninstalled.

FIG. 8C is a schematic cross sectional view of a portion of a proximity payment device, according to some embodiments.

FIG. 8D is a schematic cross sectional view of a portion of a proximity payment device, according to some embodiments.

FIGS. 9A-9B are perspective views of a proximity payment device, according to some embodiments.

FIGS. 10A-10B are perspective views of a proximity payment device, according to some embodiments.

FIG. 11A is a plan view of a structure that includes a small IC card blank and a larger carrier for the small IC card blank, in accordance with some embodiments.

FIG. 11B is a perspective view of the structure of FIG. 11A as the small IC card is being detached from the carrier.

FIG. 12 is a plan view of a structure that includes a small IC card blank and a larger carrier for the small IC card blank, in accordance with some embodiments.

FIG. 13 is a plan view of a structure that includes a small IC card blank and a larger carrier for the small IC card blank, in accordance with some embodiments.

### DETAILED DESCRIPTION

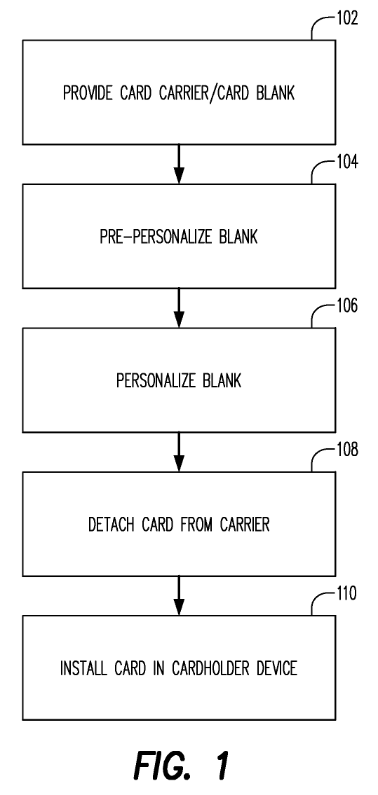

FIG. 1 is a flow chart that illustrates a process for making a proximity payment device according to some embodiments.

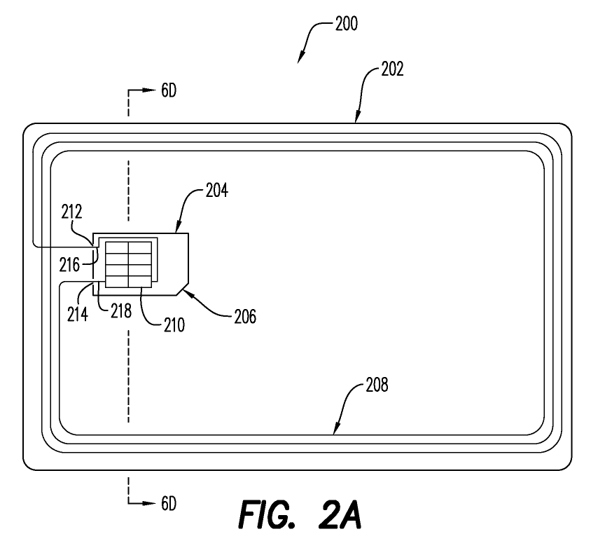

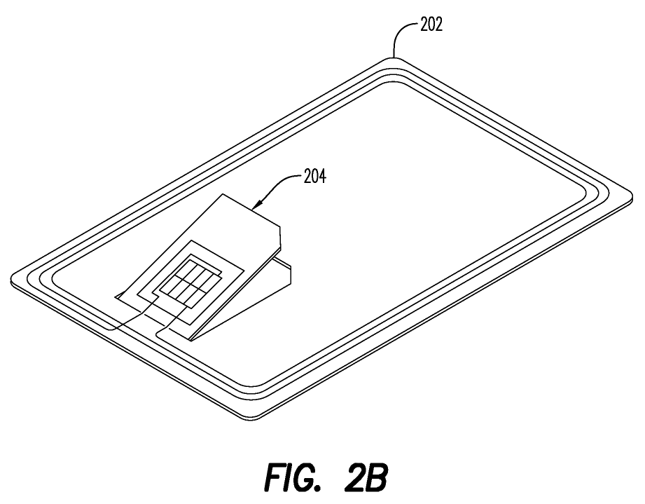

At 102, a card carrier and associated small IC card blank are provided. In some embodiments, the card carrier and small IC card blank may be similar to known constructions. FIG. 2A is a plan view of a structure 200, according to some embodiments, which includes a card carrier, indicated by reference numeral 202, and a small IC card blank (sometimes referred to hereinafter as a small IC card) indicated by reference numeral 204. The carrier 202 may be generally card-shaped and may have dimensions as defined for the standard card referred to as “ID1” in ISO/IEC standard 7810, promulgated by the International Standardization Organization and other bodies. The small IC card 204 may have dimensions as defined for the standard card/module referred to as “ID000” in the same document no. 7810. The small IC card 204 may be substantially defined within the body of the carrier 202 by substantial or nearly complete punching or scoring of the body of the carrier 202, which punching or scoring is indicated at 206. The carrier 202 includes an antenna 208 embedded therein. The antenna 208 may take the form of several loops that run along the periphery of the carrier 202, as shown in FIG. 2A. Alternatively, the antenna 208 may be of a different type and/or configuration. The antenna may be operative generally in accordance with the above-mentioned PayPass standard to receive interrogation and power signals (which may be the same signal) from a proximity coupling device of a POS terminal and to transmit payment card account number information and/or other information to the proximity coupling device.

The small IC card 204 includes an IC indicated at 210, on which several contact pads (not separately assigned numerals in FIG. 2A) are formed.

The carrier 202 constitutes a “surrounding card” that surrounds and carries the small IC card blank 204.

In some embodiments, the body of the small IC card 204 may be joined to the body of the carrier 202 by, and only by, a few bridges at the periphery of the body of the small IC card 204. Two such bridges are shown, at 212 and 214, although others may be present. The bridges may be formed as locations around the periphery of the small IC card 204 at which the scoring or punching has not occurred.

The IC 210 of the small IC card 204 may be electrically conductively coupled to the antenna by electrically conductive connections 216, 218 which respectively run along the bridges 212, 214. In other words, the electrically conductive connections 216, 218 may be at least partially embedded in the bridges 212, 214, respectively.

One or more surfaces of the small IC card 204 may carry one or more logos and/or brands, including for example the brand/logo of a national payment card association such as MasterCard International Incorporated. The brand/logo of the issuer may also be present, as well as, for example, a specific card product brand. Other features that may be present on the small IC card 204 (though such features are not shown) are an adhesive paper strip to receive the signature of the cardholder, and a security code or the like printed on the adhesive strip.

At 104 in FIG. 1, a process step customarily referred to as “pre-personalization” is performed with respect to the small IC card 204. As is familiar to those who are skilled in the art, pre-personalization entails writing into the IC 210, via radio frequency communication (received by the IC 210 via the antenna 208), certain information such as loading of keys to be used in subsequent transactions and setting of parameters (such as to select a particular card brand to be borne by the small IC card 204). In addition, information such as a payment card association brand, etc., may be printed on the small IC card 204 as part of the pre-personalization process. It will be appreciated that the information stored in the IC 210 and/or printed on the small IC card 204 may be such as is common to all small IC cards processed in a particular production run.

At 106 in FIG. 1, a process step customarily referred to as “personalization” is performed with respect to the small IC card 204. In the personalization step, the small IC card 204 is effectively assigned to a particular payment card account and/or a particular account holder by writing into the IC 210 (again via radio frequency communication through the antenna 208) information such as a payment card account number and the name of the account holder. Other information, such as expiration date, may be stored in either of the pre-personalization and personalization steps. Moreover, the pre-personalization and personalization steps may be combined in one operation. Such an operation (or operations, if the steps are performed separately) may be performed by use of an item of conventional contactless card programming equipment, such as the model 9000 available from Datacard Group, Minnetonka, Minn.

In accordance with some embodiments, the structure 200 may thereafter be used as a proximity payment device. As further described hereinafter, the small IC card 204 may also be detached from the carrier 202 and installed in one or more other proximity payment devices.

In accordance with some embodiments, the payment card account number and/or any other information (or a portion thereof) that was (or is to be) stored in the IC 210 may be printed on a surface of the small IC card 204. In accordance with some embodiments, the printing of the payment card account number on the small IC card 204 may be by use of the above-mentioned Datacard 9000 equipment or by another suitable device with printing capabilities.

In some embodiments, information printed on the small IC card 204 may be the same as and/or similar to information printed on a small IC card 204 in one or more embodiments disclosed in U.S. patent application Ser. No. ______, entitled “IMPROVED IDENTIFICATION OF INSTALLABLE CARD”, filed in the name of Simon Phillips on even date herewith, having attorney docket number P00238-US-UTIL, the contents of which are hereby incorporated by reference.

At 108 in FIG. 1, the small IC card 204 is detached from the carrier 202. For example, this may be done by the account holder, after the carrier 202, with the small IC card 204, is mailed to the account holder. FIG. 2B is a perspective view of the small IC card 204 and the carrier as the small IC card 204 is being detached therefrom. As seen in FIG. 2B, the detaching of the small IC card 204 from the carrier 202 may be accomplished by snapping the small IC card 204 from the bridges 212, 214. This breaks the bridges 212, 214 and detaches the IC 210 from the antenna 208 of the carrier 202.

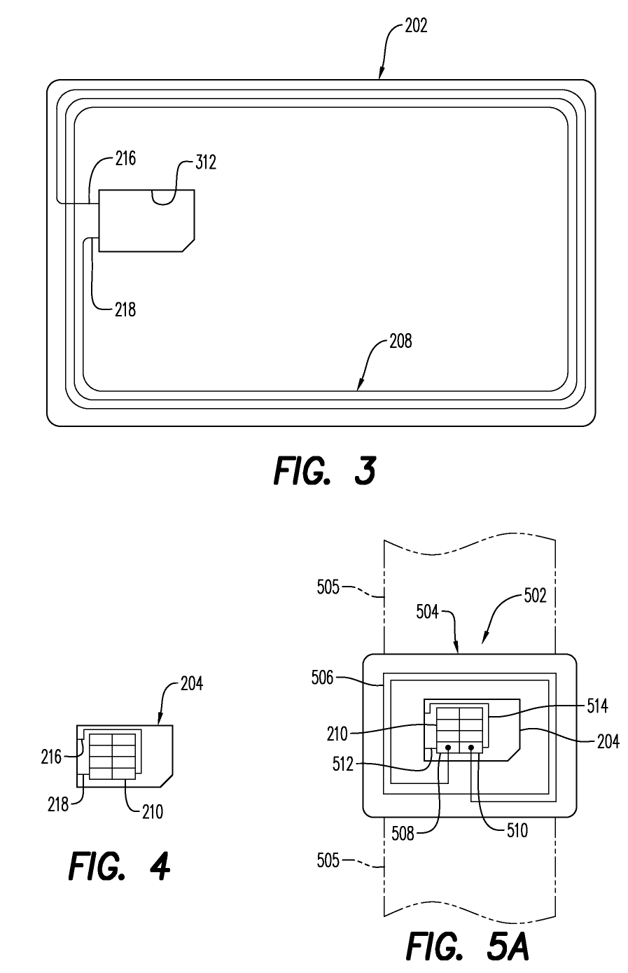

FIG. 3 is a plan view of the carrier 202 in its condition after the small IC card 204 has been detached from the carrier 202. FIG. 4 is a plan view of the small IC card 204 after it has been detached from the carrier 202. It will be noted from both of FIGS. 3 and 4 that the connections 216, 218 between the IC 210 and the antenna 208 have been severed by the act of detaching the small IC card 204 from the carrier 202. The detaching of the small IC card 204 leaves behind an aperture 312 in the carrier 202.

At 110 in FIG. 1, the small IC card 204 is installed in a device so that the device becomes a proximity payment device. The device may be, for example, a wristwatch, a wristband or a bracelet. The device may include an antenna to which the IC 210 is coupled by the installation of the small IC card 204 in the device. This may be done by spring-loaded or spring contacts in the device brought into contact with contact pads on the IC 210 by the process of installing the small IC card 204 in the device.

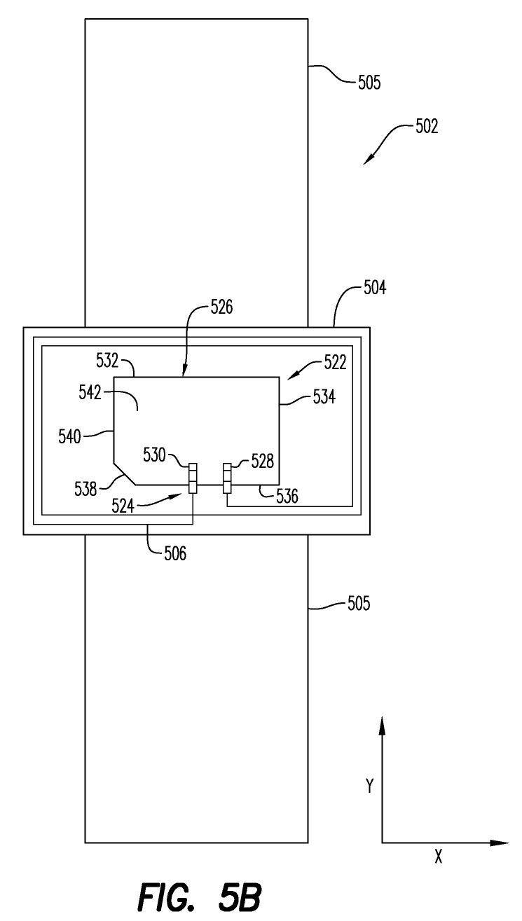

FIG. 5A is a schematic view of an example embodiment of a proximity payment device 502 of the type which may be provided at step 110. Reference numeral 504 indicates the body of the proximity payment device 502, with the small IC card 204 installed in the body 504. If the proximity payment device 502 is a wristwatch, the body 504 may be the case of the wristwatch, and other functional components of the wristwatch, such as a movement, a numeric liquid crystal display, a wristwatch chip, a battery, etc., may be present but are not shown in the drawing. The proximity payment device 502 may further include a wrist band 505 or the like which may be secured to the body 504. The proximity payment device 502 need not be a wristwatch but may rather be a wristband or a bracelet, or a pendant, or any other type of device.

The proximity payment device 502 also includes an antenna 506 contained in and/or supported on the body 504 of the proximity payment device 502. The antenna 506 is electrically conductively coupled to the IC 210 of the small IC card 204. The coupling of the IC 210 to the antenna 506 may be via the same contact pads 508, 510 by which the IC 210 was previously coupled to the antenna 208 of the carrier 202 (FIG. 2A). It will be observed from FIG. 5A that stubs 512, 514 of the connections to the (temporary) antenna 208 are still coupled to the contact pads 508, 510, respectively.

As shown, the antenna 506 may be in the form of several loops arranged in and/or supported on the proximity payment device 502. Alternatively, the antenna 506 may be of a different type and/or configuration. The antenna may be operative generally in accordance with the above-mentioned PayPass standard to receive interrogation and power signals (which may be the same signal) from a proximity coupling device of a POS terminal and to transmit payment card account number information and/or other information to the proximity coupling device.

FIG. 5B is a schematic plan view of a portion of the proximity payment device 502, in accordance with some embodiments, prior to installing the small IC card 204 therein. Referring to FIG. 5B, the proximity payment device 502 may include a holder 522 and an electrical interface 524. The holder 522 may include a seat 526 adapted to receive the small IC card 204 and to support and/or position the small IC card 204 relative to the electrical interface 524, at least in part. The electrical interface 524 may include first and second contacts 528, 530, which may be adapted to contact the contacts 508, 510, respectively, of the IC 210 of the small IC card 204. The contacts 528, 530 may also be electrically connect to the antenna 506, to thereby electrically connect the antenna 506 to the contacts 508, 510 of the IC 210 of the small IC card 204.

The seat 526 may include a plurality of surfaces 532-540, which may be adapted to abut surfaces of the small IC card 204 to support and/or position the small IC card 204 in the x and y directions, at least in part. The seat 526 may further include a surface 542 adapted to support and/or position the small IC card 204 in the z direction (i.e., perpendicular to the x and y directions) at least in part.

The contacts 528, 530 may be biased (e.g., in the z direction) so as to help insure contact with respective contacts of the IC 210 of the small IC card 204. In some embodiments, each of the contacts 528, 530 may comprise a spring contact that includes a contact and a spring integral therewith to bias the spring contact (e.g., in the z direction).

In some embodiments, the holder 522 and/or the electrical interface 524 may be disposed within the body 504 of the proximity payment device 502. In such embodiments, one or more portions of the body 504 may be movable and/or removable to access the holder 522 and/or electrical interface 524 of the proximity payment device 502.

The proximity payment device 502 may operate in a conventional manner. For example, the proximity payment device may operate in accordance with the above-mentioned “PayPass” standard. The proximity payment device 502 may be presented to a proximity coupling device (not shown) of a POS terminal (not shown) to accomplish payment for a sales transaction. The proximity coupling device may transmit an interrogation signal. The proximity payment device 502 may receive the interrogation signal via the antenna 506. The received interrogation signal may cause the IC 210 to be powered-up. For example, the IC 210 may rectify the received interrogation signal to generate a DC power level. The IC 210 may transmit a signal to the proximity coupling device in response to the interrogation signal. The IC 210 may transmit the signal (and possibly one or more additional signals) to the proximity coupling device via the antenna 506. One or more signals transmitted by the IC 210 may include a payment card account number and/or other information required for interaction with the proximity coupling device. In some embodiments, the IC 210 may transmit the payment card account number and/or other information via the antenna 506 after a handshake procedure or the like with the POs terminal. The POS terminal may then interact with a payment card system to charge the current sales transaction to the payment card account represented by the payment card account number received from the proximity payment device 502.

In some embodiments, a user may remove the small IC card 204 from the proximity payment device 502. Such small IC card 204 may thereafter be (i) installed into another proximity payment device 502 and/or (ii) replaced by another small IC card 204, the latter of which may be installed in the proximity payment device 502.

The structure 200 may be fabricated in any manner.

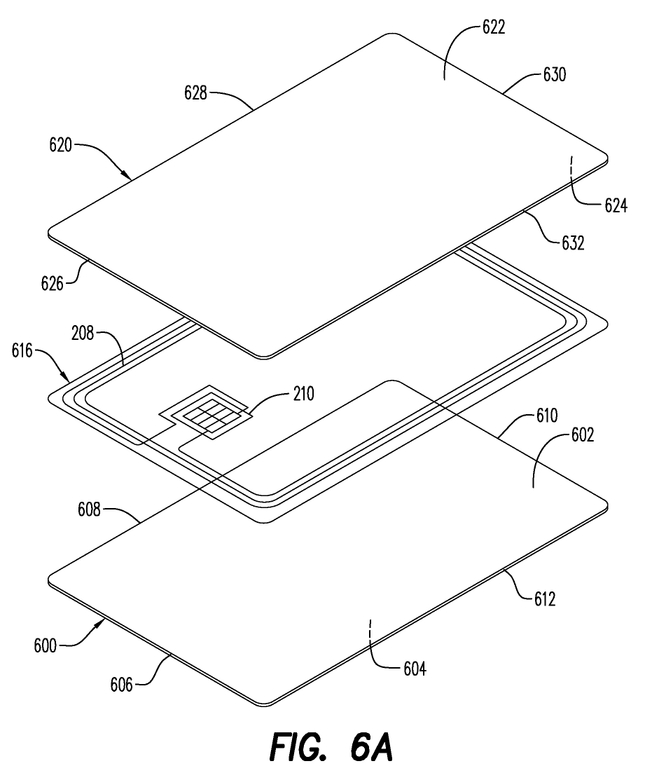

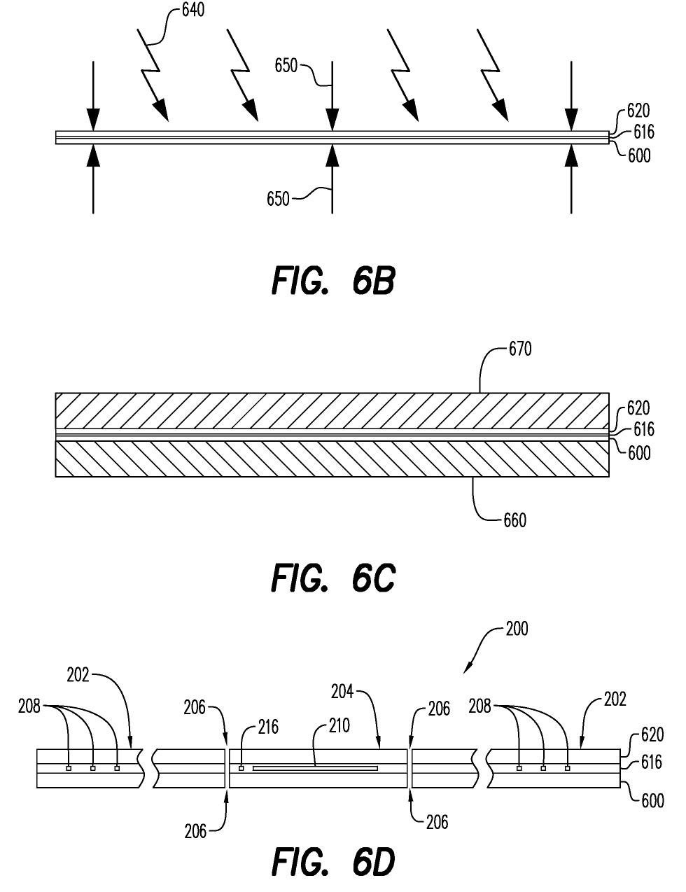

FIGS. 6A-6D show a method for fabricating the structure 200, in accordance with some embodiments. Referring to FIG. 6A, a first layer 600 may be provided. The first layer 600 may be card shaped with major outer surfaces 602, 604 and edges 606, 608, 610, 612. A central portion, indicated at 616 and sometimes referred to herein as an “inlay”, may be disposed on one of the major outer surfaces 602, 604 of the first layer 600. The central portion 616 may include the antenna 208 and the IC 210. A second layer 620 may be disposed on the central portion. As with the first layer 610, the second layer 620 may be card shaped with major outer surfaces 622, 624 and outer edges 616, 618, 620, 622. The outer edges 616, 618, 620, 622 of the second layer 620 may be disposed in register with the outer edges 606, 608, 610, 612 of the first layer 600.

Referring to FIG. 6B, heat 640 and/or pressure 650 may be applied to the first layer 600 and/or the second layer 620. The heat 640 and/or pressure 650 may cause the first layer 600 and the second layer 620 to become bonded to one another so as to trap the antenna 208 and the IC 210 therebetween. In some embodiments, the first layer 600 and the second layer 620 are each formed of plastic or other suitable material.

Referring to FIG. 6C, one or more platens 660, 670 may be employed to provide such heat 650 (FIG. 6C) and/or pressure 640 (FIG. 6C).

Referring to FIG. 6D, a schematic cross sectional view of one embodiment of the structure 200 taken in a direction 6D-6D of FIG. 2A, one or more portion of the first layer 600 and/or one or more portion of the second layer 620 may be removed, e.g., by punching or scoring indicated at 206 (FIG. 2A), to define the inner periphery of the carrier 202 (FIG. 2A), the outer periphery of the small IC card blank 204 (FIG. 2A) and one or more of the one or more bridges, e.g., bridges 212, 214 (FIG. 2A).

As stated above, in some embodiments, the proximity payment device 502 may be a wristwatch, a wristband, a bracelet, a pendant, etc.

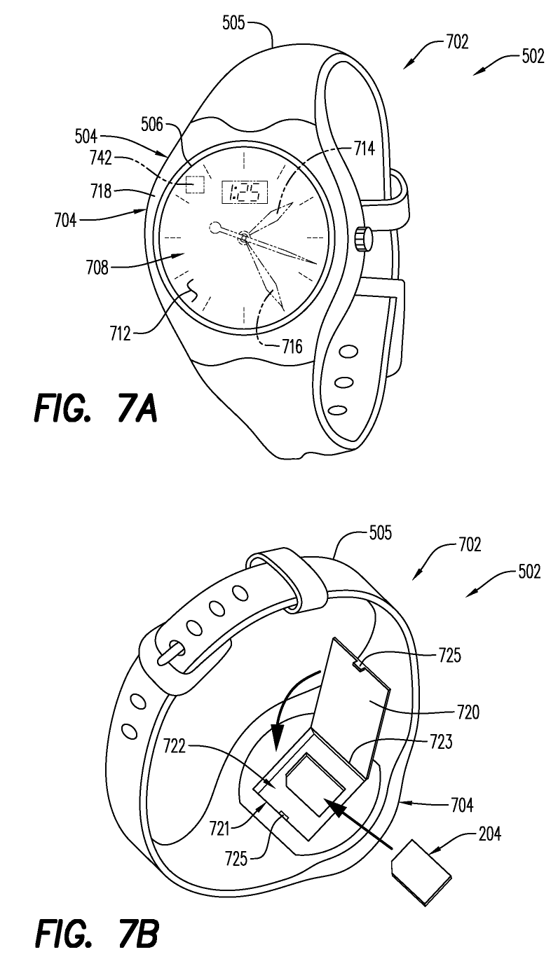

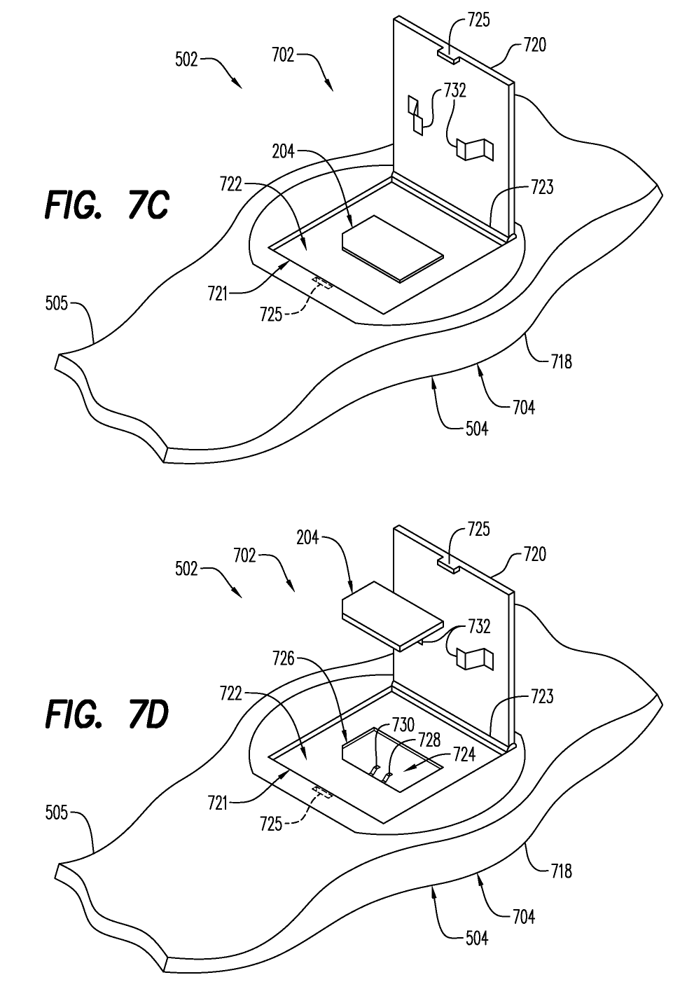

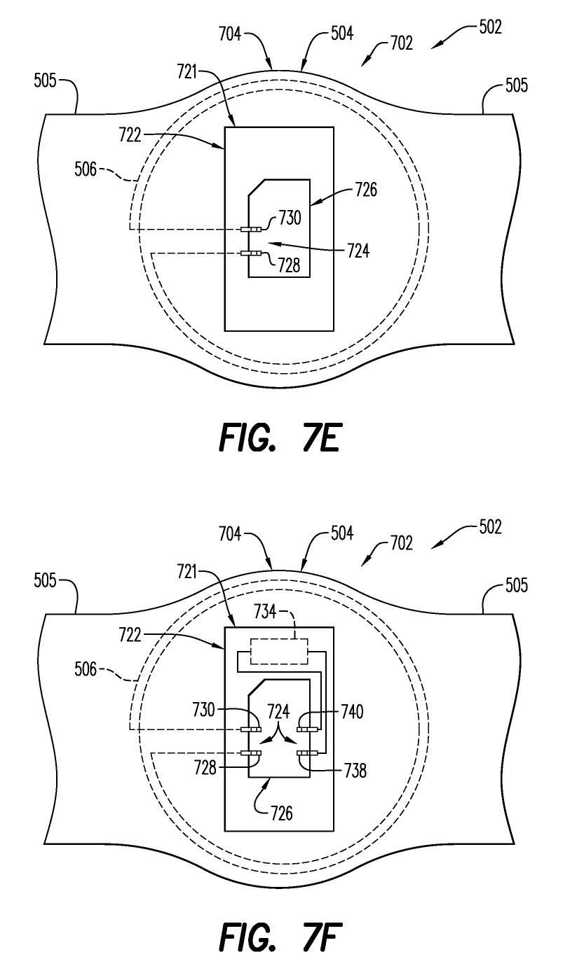

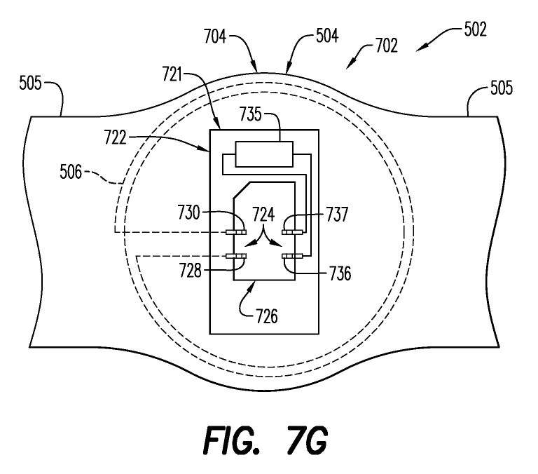

FIGS. 7A-7B are perspective views of a proximity payment device 502 that comprises a wristwatch 702, according to some embodiments. Referring to FIGS. 7A-7B, the wristwatch 702 may include a body 504 and a wristband 505 secured to the body 504. The body may define a case 704, which may enclose the antenna 506, a display 708, a power source (e.g., a power source 734 (FIG. 7F)), and/or one or more other components (e.g., a movement (not shown), a wristwatch chip (not shown), etc.) of the wristwatch 702. The display 708 may indicate time and may comprise an analog display and/or a digital display. An analog display may include a dial (or graduated face) 712 and one or more rotating members (or hands) 714, 716. A digital display may include a numerical display (e.g., a numeric liquid crystal display or numeric LED display) (not shown).

The case 704 may include one or more portions, e.g., a front portion 718 and a back portion 720. The front portion 718 may be substantially transparent to allow the display 708 to be seen therethrough. One or more portions of the case 704 may be movable relative to one or more other portions of the case 704 to allow access to an internal chamber 721 of the wristwatch 702. For example, one side of the back portion 720 may be retained by a hinge 723 and the other side of the back portion 720 may be retained by a releasable catch 725, such that upon releasing the releasable catch, one side the back portion 720 may be free to pivot away from the rest of the case 704.

FIG. 7C is a schematic, perspective view of a portion of the wristwatch 702, according to some embodiments, with the case 704 in an open state.

FIG. 7D is a schematic, partially exploded perspective view of a portion of the wristwatch 702, according to some embodiments, with the case 704 in an open state and the small IC card 204 uninstalled.

FIG. 7E is a schematic plan view of a portion of the wristwatch 702, according to some embodiments, with the case 704 removed and the small IC card 204 uninstalled. Referring to FIG. 7E, the wristwatch 702 may include a holder 722 and an electrical interface 724. The holder 722 may include a seat 726 adapted to receive the small IC card 204 and to support and/or position the small IC card 204 relative to the electrical interface 724, at least in part. The electrical interface 724 may include first and second contacts 728, 730, which may be adapted to contact the contacts 508, 510, respectively, of the IC 210 of the small IC card 204. The contacts 728, 730 may also electrically connect to the antenna 506, to thereby electrically connect the antenna 506 to the contacts 508, 510 of the IC 210 of the small IC card 204. The contacts 728, 730 may be biased (e.g., in the z direction) so as to help insure contact with respective contacts of the IC 210 of the small IC card 204. In some embodiments, each of the contacts 728, 730 may comprise a spring contact that includes a contact and a spring integral therewith to bias the spring contact (e.g., in the z direction). One or more springs 732 may be provided on the back portion 720 of the case 704 to bias the small IC card 204 toward the holder 722.

In some embodiments, the holder 722, the electrical interface 724, the seat 726, and contacts 728, 730 are the same as and/or similar to the holder 522, the electrical interface 524, the seat 526 and contacts 528, 530, respectively, of the proximity payment device 502 described hereinabove with respect to FIGS. 5A-5B. As stated above, in some embodiments, the proximity payment device 502 may further include a power source, e.g., a battery. The IC 210 of the small IC card 204 may be adapted to be connected to and/or receive electrical power from such power source.

FIG. 7F is a schematic plan view of a portion of a wristwatch 702 that comprises a power source, e.g., a battery, 734, in accordance with some embodiments. In some embodiments, the IC 210 of the small IC card 204 may include contacts adapted to be connected to and/or receive electrical power from the power source 734. To that effect, the electrical interface 724 may further include third and fourth contacts 738, 740, which may be adapted to contact the contacts of the IC 210 of the small IC card 204 that are adapted to be connected to and/or receive electrical power from the power source 734. The contacts 738, 740 may also electrically connect to the power source 734, to thereby electrically connect the power source 734 to the contacts of the IC 210 of the small IC card 204 that are adapted to be connected to and/or receive electrical power from the power source 734. The contacts 738, 740 may be biased (e.g., in the z direction) so as to help insure contact with respective contacts of the IC 210 of the small IC card 204. In some embodiments, each of the contacts 738, 740 may comprise a spring contact that includes a contact and a spring integral therewith to bias the spring contact (e.g., in the z direction).

Access to a source of electrical power may improve one or more operating characteristics of the device. In some embodiments, access to a source of electrical power may give the proximity payment device a greater range. If the proximity device has a greater range, it may not need to be positioned as close to the proximity coupling device. In some embodiments, access to a source of electrical power may allow the device to perform a greater number of functions and/or may increase the operating speed of the device.

In some embodiments, the wristwatch 702 and/or other type of proximity payment device 502 may further include a controller. The IC 210 of the small IC card 204 may be adapted to be connected to the controller.

FIG. 7G is a schematic plan view of a portion of a wristwatch 702 that comprises a controller 735, in accordance with some embodiments. Referring to FIG. 7G, in some embodiments, the IC 210 of the small IC card 204 may include contacts adapted to be connected to the controller 735. To that effect, the electrical interface 724 may include fifth and sixth contacts 736, 737, which may be adapted to contact the contacts of the IC 210 of the small IC card 204 that are adapted to be connected to the controller 735. The contacts 736, 737 may also electrically connect to the controller 735, to thereby electrically connect the controller 735 to the contacts of the IC 210 of the small IC card 204 that are adapted to be connected thereto. In some embodiments, the controller 735 comprises a control circuit.

The contacts 736, 737 may be biased (e.g., in the z direction) so as to help insure contact with respective contacts of the IC 210 of the small IC card 204. In some embodiments, each of the contacts 736, 737 may comprise a spring contact that includes a contact and a spring integral therewith to bias the spring contact (e.g., in the z direction).

Each portion of proximity payment device 502 may comprise any type of material(s) and may have any configuration and/or construction. Thus, for example, the case 704 may comprise any type of material(s) and may have any configuration and/or construction. In some embodiments, the case may comprise a metal, ceramic, glass, plastic, fiber, silicon, semiconductor, and/or a combination thereof. Likewise, a holder 522 and/or seat 526 may have any configuration (e.g., shape and/or size) including for example, rectangular, cylindrical, elliptical, conical, irregular and/or any combination thereof. In some embodiments, the configuration may be based on the configuration of the small IC card to be received and/or any other consideration(s) or combination thereof.

In some embodiments, a wristwatch 702 and/or other type of proximity payment device 502 may be adapted to receive more than one small IC card 204. In some embodiments, a wristwatch 702 and/or other type of proximity payment device 502 may be the same as and/or similar to one or more embodiments of a wristwatch 702 and/or other type of proximity payment device disclosed in U.S. patent application Ser. No. ______, entitled “IDENTIFICATION TOKEN AND METHOD OF MAKING IDENTIFICATION TOKEN”, filed in the name of Simon Phillips on even date herewith, having attorney docket number M01.052, the contents of which are hereby incorporated by reference.

In some embodiments, the small IC card 204 may be enabled at all times. In some other embodiments, the small IC card may be enabled only at selected times. In some embodiments, a wristwatch 702 or other type of proximity payment device 502 may include an input device to enable selective operation of the small IC card 204.

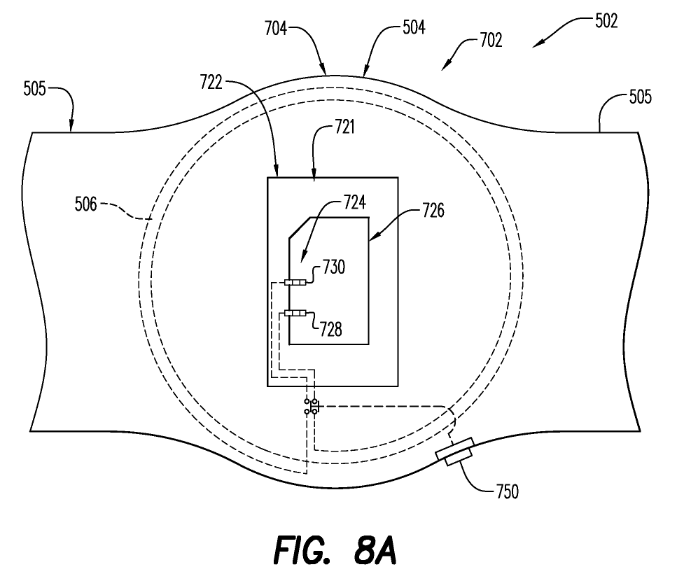

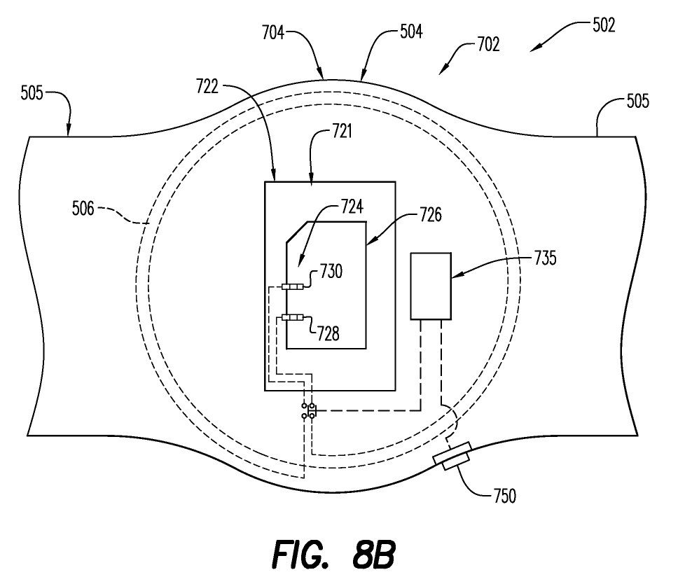

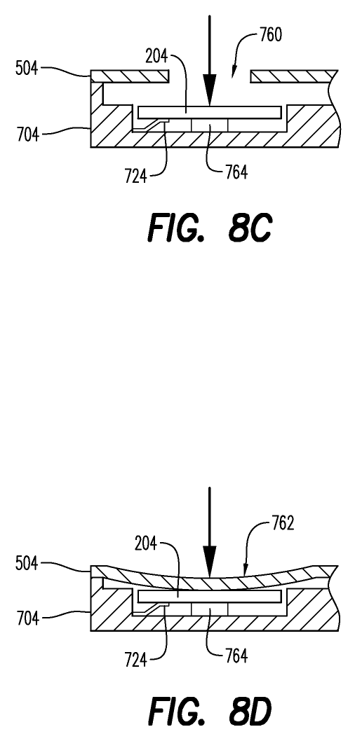

FIG. 8A is a schematic plan view of a portion of the wristwatch 702, according to some embodiments, with the case 704 removed and the small IC card 204 uninstalled. Referring to FIG. 8A, in accordance with some embodiments, wristwatch 702 may include an input device 750 to enable selective operation of the small IC card 204. In some embodiments, the input devices 750 may comprise a push-button switch or other type of tactile input device. Other types of input devices may also be used. The input device 750 may be disposed on the case 704 or at any other suitable location

In some embodiments, the input device 750 may include a switch connected in series between the contacts 728, 730 and the antenna 506. By actuating the input device 750, the contacts 728, 730 may be electrically connected to the antenna 506 (via the switch of the input device 750) to thereby electrically connect the antenna 506 to the contacts 508, 510 of the IC 210 of the small IC card 204 and enable operation of the small IC card 204. Thus, the input device 750 may enable selective operation of the small IC card 204.

In some embodiments, the input device 750 may be electrically connected to the controller 735 but may not be electrically connected between the electrical interfaces 724A, 724B and the antenna 506. In some embodiments, a switch electrically connected between the contacts 728, 730 and the antenna 506 may be controlled by the controller 735.

FIG. 8B is a schematic plan view of a portion of the wristwatch 702, according to some embodiments, with the case 704 removed and the small IC card 204 uninstalled. Referring to FIG. 8B, in accordance with some embodiments, the input device 750 may be connected to the controller 735, which may control the switches electrically between the contacts 728A, 730A, 728B, 730B and the antenna 506.

Actuating the input device 750 may cause a signal to be supplied to the controller 735, which may in turn supply a control signal that causes the switch to close. With the switch closed, the contacts 728, 730 may be electrically connected to the antenna 506 (via the switch controlled by the control circuit) to thereby electrically connect the antenna 506 to the contacts 508, 510 of the IC 210 of the small IC card 204 and enable operation of the small IC card 204. In some embodiments, the controller 735 may supply a control signal that causes the switch to open. In some embodiments, the controller 735 may supply such control signal after a predetermined delay.

In some embodiments, the controller 735 may be disposed within the proximity payment device 502. If the device 502 includes a battery, e.g., the battery 734, the controller 735 may be powered at least in part by such battery. In some embodiments, the controller 735 may include at least one control circuit and/or at least one timer circuit.

In some embodiments, the controller 735 may (i) receive information from the small IC card 204 and/or (ii) supply information in regard to the small IC card 204. In some embodiments, one or more portions of the information supplied by the controller 735 may be supplied to the display. In some embodiments, the information supplied by the controller 735 includes one or more signals that identifies the small IC card 204, indicates whether the small IC card 204 is enabled and/or how to enable the small IC card 204. In some embodiments, such information is based at least in part on information received from the small IC card 204.

The display 708 may display information based at least in part on the information supplied thereto. Thus in some embodiments, the display may display information that identifies the small IC card 204, indicates whether the small IC card 204 is enabled and/or how to enable the small IC card 204.

In some embodiments, the display 708 may define an indicator 742. In some embodiments, the indicator 742 displays information regarding the small IC card 204. In some embodiments, the indicator may provide a visual indication that may identify the small IC card 204, indicate how to enable the small IC card 204 and/or whether the small IC card 204 is enabled. In some embodiments, a visual indication may comprise a blinking indication. In some embodiments, indicator 742 may be defined by a discrete light bulb and/or a discrete light emitting diode (LED) rather than by display device 708.

In some embodiments, the information supplied to and/or by the display may define one or more logos and/or brands. In some embodiment, the one or more logos and/or brands may include (i) a brand and/or logo of a national payment card association such as MasterCard International Incorporated, (ii) a brand and/or logo of an issuer and/or merchant associated with the small IC card 204 and/or (iii) a brand and/or logo of a specific card product. In some embodiments, a brand and/or logo may comprise a mark that is registered in one or more country or jurisdiction and/or protected under trademark law in one or more country or jurisdiction.

In some embodiments, one or more portions of the information supplied to and/or by the display may comprise one or more bit map. In some embodiments, a bit map identifies the small IC card 204. In some embodiments, a bit map defines one or more logos and/or brands. In some embodiments, a bit map supplied by the controller is based at least in part on a bit map received from the small IC card 204.

In some embodiments, indicator 742 may comprise audio indicators and/or vibratory indicators in addition to and/or in lieu of indicators that provide visible indication. An audio indicator may provide an audible indication and/or a beeping audible indication. A vibratory indicator may provide a vibratory indication. In some embodiments, the indication may identify the small IC card 204, indicate how to enable the small IC card 204 and/or whether the small IC card 204 is enabled.

In some embodiments, one more springs 764 may bias the small IC card 204 away from the electrical interface 724 such that the small IC card 204 does not contact the electrical interface 724 unless the small IC card 204 is depressed, directly and/or indirectly.

FIGS. 8C-8D are schematic cross sectional views of a portion of the wristwatch 702, in accordance with some embodiments. Referring to FIGS. 8C-8D, in some embodiments, the case 704 may define one or more openings 760 and/or movable portions 762, which may be disposed in register with the small IC card 204, to allow the small IC card 204 to be depressed, directly and/or indirectly. The contacts 728, 730 of the electrical interface 724 may also electrically connect to the antenna 506. By depressing the small IC card 204, directly and/or indirectly, the contacts 728, 730 of the electrical interface may be electrically connected to the contacts 508, 510 of the IC 210 of the small IC card 204, to thereby electrically connect the antenna 506 to the contacts 508, 510 of the IC 210 of the small IC card 204 and enable operation of the small IC card 204.

In some embodiments, the switch may be connected in series between the contacts 508, 510 of the small IC card 204 and the contacts of the electrical interface 724 instead of between the contacts 728, 730 of the electrical interface 724 and the antenna 506. In some embodiments, the switch may be actuated by the input device 750. For example, the switch may be part of the input device 750. The contacts 728, 730 of the electrical interface 724 may be electrically connected to the antenna 506. By actuating the input device 750, the contacts 728, 730 may be electrically connected to the contacts 508, 510, respectively, of the IC 210 of the small IC card 204 (via the switch) to thereby electrically connect the antenna 506 to the contacts 508, 510 of the IC 210 of the small IC card 204 and enable operation of the small IC card 204.

In some embodiments, a switch connected in series between the contacts of the small IC card 204 and the contacts of the electrical interface 724 may be controlled by the controller 735 instead of the input device 750. In such embodiments, the input device 750 may be connected to the controller 735. Actuating the input device 750 may cause a signal to be supplied to the controller 735, which may in turn supply a control signal that causes the switch to close. With the switch closed, the contacts 728, 730 (which may be electrically connected to the antenna 506) may be electrically connected to the contacts 508, 510 of the IC 210 of the small IC card 204, to thereby electrically connect the antenna 506 to the contacts 508, 510 of the IC 210 of the small IC card 204 and enable operation of the small IC card 204. In some embodiments, the controller 735 may supply a control signal that causes the switch to open. In some embodiments, the controller 735 may supply such control signal after a predetermined delay.

In some embodiments, the small IC card 204 may be enabled and/or disabled in accordance with one or more methods disclosed in U.S. patent application Ser. No. ______, entitled “ENABLING IDENTIFICATION TOKEN FOR A TIMED PERIOD”, filed in the name of Simon Phillips on even date herewith, having attorney docket number P00239-US-UTIL, the contents of which are hereby incorporated by reference.

In some embodiments, the input device, the switch and/or the controller may be the same as and/or similar to one or more of the devices, switches and/or circuits disclosed in U.S. patent application Ser. No. ______, entitled “ENABLING IDENTIFICATION TOKEN FOR A TIMED PERIOD”, filed in the name of Simon Phillips on even date herewith, having attorney docket number P00239-US-UTIL, the contents of which are hereby incorporated by reference.

Some embodiments may use one or more of the techniques disclosed in U.S. patent application Ser. No. ______, entitled “METHOD FOR USE IN ASSOCIATION WITH IDENTIFICATION TOKEN AND APPARATUS INCLUDING IDENTIFICATION TOKEN”, filed in the name of Simon Phillips et al. on even date herewith, having attorney docket number M01.073, the contents of which are hereby incorporated by reference.

In some embodiments, printed information may be provided by the proximity payment device 502. In some embodiments, printed information includes an indication of a location of a switch and/or other type of input device. Thus the indication may indicate to the cardholder (the user) where the user should press with his/her finger to actuate a switch. In some embodiments, the indication may be provided on the body of the proximity payment device. If the body defines a case the indication may be provided on such case. If the proximity payment device includes a display, the indication may be provided on the display. In some embodiments, the indication may be provided on the small IC card 204. In some embodiments, the card may include information thereon and a back portion of the case and/or another portion of the case may be transparent and/or open to allow the information to be read.

In some embodiments, the small IC card may include an antenna.

As stated above, in some embodiments, the proximity payment device 502 may be a wristband, a bracelet, a pendant, etc.

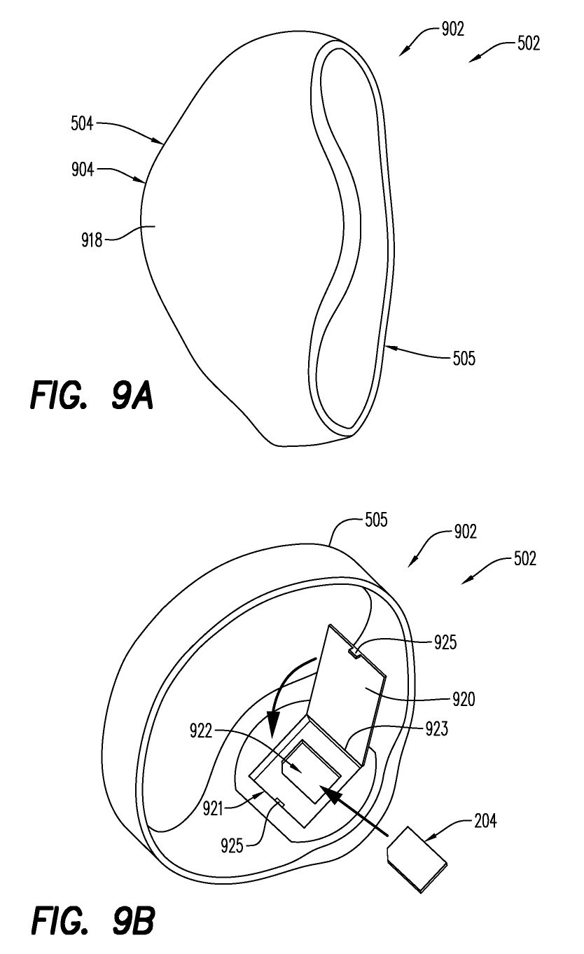

FIGS. 9A-9B are perspective views of a proximity payment device 502 that comprises a wristband 902, according to some embodiments. Referring to FIGS. 9A-9B, the wristband 902 may include a body 504 and a wristband 505 secured to the body 504. The body may define a case 904, which may enclose the antenna 506 and/or one or more other components of the proximity payment device.

The case 904 may include one or more portions, e.g., a front portion 918 and a back portion 920. One or more portions of the case 904 may be movable relative to one or more other portions of the case 904 to allow access to an internal chamber 921 of the wristband 902. For example, one side of the back portion 920 may be retained by a hinge 923 and the other side of the back portion 920 may be retained by a releasable catch 925, such that upon releasing the releasable catch, one side the back portion 920 may be free to pivot away from the rest of the case 904.

The wristband 902 may include a holder 922 and an electrical interface 924, which may be the same as and/or similar to (i) the holder 522 and the electrical interface 524, respectively, of the proximity payment device 502 described hereinabove with respect to FIGS. 5A-5B and/or (ii) the holder 722 and the electrical interface 724, respectively, of the proximity payment device 502 described hereinabove with respect to FIGS. 7A-7G.

The wristband 902 may include a display, a battery and/or a controller. In some embodiments, the display may be the same and/or similar to the display 708 of the proximity payment device 502 described hereinabove with respect to any one or more of FIGS. 7A-7F, 8A-8D. In some embodiments, the battery may be the same and/or similar to the battery 734 of the proximity payment device 502 described hereinabove with respect to any one or more of FIGS. 7A-7F, 8A-8D. In some embodiments, the controller may be same and/or similar to the controller 735 of the proximity payment device 502 described hereinabove with respect to any one or more of FIGS. 7A-7F, 8A-8D.

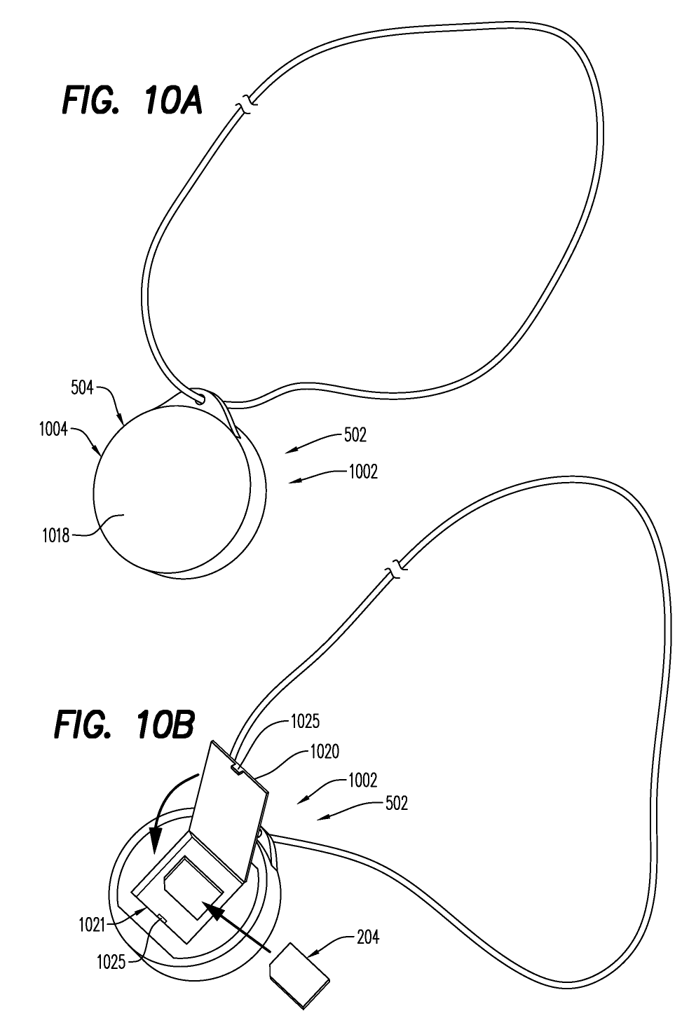

FIGS. 10A-10B are perspective views of a proximity payment device 502 that comprises a pendant 1002, according to some embodiments. Referring to FIGS. 10A-10B, the pendant 1002 may include a body 504 and a band 505 secured to the body 504. The body may define a case 1004, which may enclose the antenna 506 and/or one or more other components of the proximity payment device.

The case 1004 may include one or more portions, e.g., a front portion 1018 and a back portion 1020. One or more portions of the case 1004 may be movable relative to one or more other portions of the case 1004 to allow access to an internal chamber 1021 of the wristband 1002. For example, one side of the back portion 1020 may be retained by a hinge 1023 and the other side of the back portion 1020 may be retained by a releasable catch 1025, such that upon releasing the releasable catch, one side the back portion 1020 may be free to pivot away from the rest of the case 1004.

The pendant 1002 may include a holder 1022 and an electrical interface 1024, which may be the same as and/or similar to (i) the holder 522 and the electrical interface 524, respectively, of the proximity payment device 502 described hereinabove with respect to FIGS. 5A-5B and/or (ii) the holder 722 and the electrical interface 724, respectively, of the proximity payment device 502 described hereinabove with respect to FIGS. 7A-7G.

The pendant 1002 may include a display, a battery and/or a controller. In some embodiments, the display may be the same and/or similar to the display 708 of the proximity payment device 502 described hereinabove with respect to any one or more of FIGS. 7A-7F, 8A-8D. In some embodiments, the battery may be the same and/or similar to the battery 734 of the proximity payment device 502 described hereinabove with respect to any one or more of FIGS. 7A-7F, 8A-8D. In some embodiments, the controller may be same and/or similar to the controller 735 of the proximity payment device 502 described hereinabove with respect to any one or more of FIGS. 7A-7F, 8A-8D.

In some embodiments, the device 502 may not have, and/or may not be used with, a wristband, a neckband, and/or any other type of band.

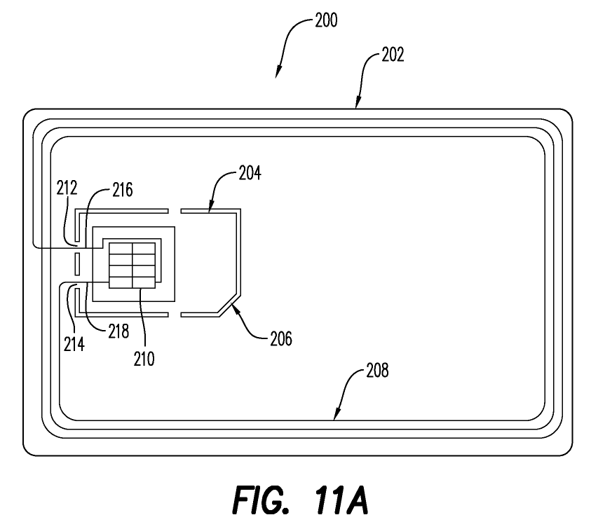

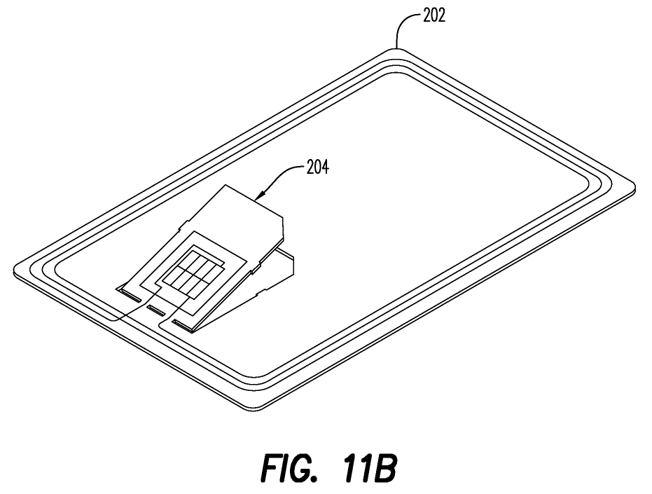

FIG. 11A is a plan view of a structure 200 that includes a small IC card blank and a larger carrier for the small IC card blank, in accordance with some embodiments. Referring to FIG. 11A, in accordance with some embodiments, the structure 200 may be similar to the structure 200 described above with respect to FIG. 2A. The body of the small IC card 204 may be joined to the body of the carrier 202 by bridges at the periphery of the body of the small IC card 204. Four bridges are shown although others may be present. The bridges may be formed as locations around the periphery of the small IC card 204 at which the scoring or punching has not occurred.

FIG. 11B is a perspective view of the structure of FIG. 11A as the small IC card is being detached from the carrier.

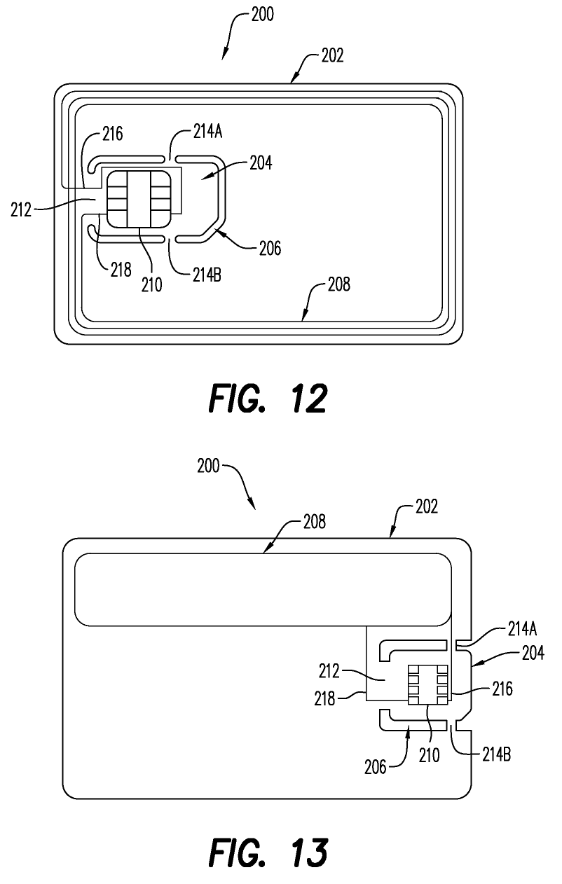

FIG. 12 is a plan view of a structure 200 that includes a small IC card blank and a larger carrier for the small IC card blank, in accordance with some embodiments. Referring to FIG. 12, in accordance with some embodiments, the structure 200 may be similar to the structure 200 described above with respect to FIG. 2A. The body of the small IC card 204 may be joined to the body of the carrier 202 by bridges at the periphery of the body of the small IC card 204. Three bridges 212, 214A, 214B are shown although others may be present. The bridges may be formed as locations around the periphery of the small IC card 204 at which the scoring or punching has not occurred.

FIG. 13 is a plan view of a structure 200 that includes a small IC card blank and a larger carrier for the small IC card blank, in accordance with some embodiments. Referring to FIG. 12, in accordance with some embodiments, the structure 200 may be similar to the structure 200 described above with respect to FIG. 2A. The small IC card 204 may have dimensions as defined for the standard card/module referred to as “ID000” in the document no. 7810 promulgated by the International Standardization Organization and other bodies. The body of the small IC card 204 may be joined to the body of the carrier 202 by bridges at the periphery of the body of the small IC card 204. Three bridges 212, 214A, 214B are shown although others may be present. The bridges may be formed as locations around the periphery of the small IC card 204 at which the scoring or punching has not occurred.

In some embodiments, use of a small card having dimensions of an “ID0000”card/module, which is smaller than a “ID000”card/module, may allow the small IC card 204 to be positioned at a location away from a vacuum cup and/or other suction devices that may be employed in programming equipment, such as the model 9000 available from Datacard Group, Minnetonka, Minn., which may be used to program the small IC card 204.

Although back portions 720, 920 and 1020 are not shown as being transparent, in some embodiments, any or all of such back portions 720, 920 and 1020 may be transparent.

Although information is not shown printed on some small IC cards 204 in some embodiments any or all of such small IC cards 204 may have information printed thereon.

Pursuant to some embodiments, the small IC card 204 is personalized with a payment card account number (otherwise referred to as a “primary account number” or “PAN”) that directly identifies a payment card account. In some embodiments, the small IC card 204 is personalized with a proxy or surrogate account number that does not, on its own, directly identify a payment card account. Instead, the proxy or surrogate account number (otherwise referred to, in the context of a MasterCard-branded payment card, as a “PayPass PAN” or “PPAN”) is translated into a PAN (e.g., during a payment transaction by a payment network or an issuer) for use in completing a transaction.

In some embodiments one or more of the circuits of the proximity payment device may include an enable line that may be used to enable and/or disable the proximity payment device. In some embodiments, methods in addition to and/or in lieu of those described herein may be employed to enable and/or disable the proximity payment device.

One or more of the proximity payment devices may also have a contact interface like that of a conventional smart card that includes a contact interface.

As used herein and in the appended claims, “proximity payment device” refers to any device, of any shape, which transmits to a point of sale terminal, by wireless transmission, a payment account number. As used herein and in the appended claims, a payment account number may be numeric, non numeric and/or a combination thereof.

The principles taught herein have heretofore been described in the context of proximity payment devices. Nevertheless, these teachings are also applicable to any type of identification token. As used herein and in the appended claims the term “identification token” refers to a device, of any shape, that serves as one or more of a proximity payment device, a transportation related device, an identification device, an RFID-enabled passport and/or a source of any type of information associated with a holder of the identification token (and/or the holder of the card installed therein). The term “transportation related device” refers to a card or other device used to pay, or confirm or evidence payment of, a charge for using a transportation system and/or cards or the like issued by transportation systems (e.g., mass transit systems) for access to the transportation systems. The term “RFID-enabled passport” refers to an internationally recognized travel document that includes an IC and an antenna and communicates with a terminal by a wireless communication technique. The term “information” may include but is not limited to a name, a social security number, an account number, an expiration date, a security code and/or medical information. As used herein, an account number may be numeric, non numeric and/or a combination thereof.

Notably, the size of the IC card compared to the rest of the structure may be different than shown. In some embodiments, the IC card may be the same size as the rest of the structure to which it is attached or even larger than the rest of the structure to which it is attached.

As used herein, the term surrounding includes both completely surrounding and partially surrounding. Thus, a surrounding card may be a completely surrounding card and/or a partially surrounding card.

Thus, in accordance with some embodiments, information other than a payment card account number (or portion thereof) that was (or is to be) stored in the IC 210 may be printed on a surface of the small IC card 204. In some embodiments, the printing may be by use of the above-mentioned Datacard 9000 equipment or by another suitable device with printing capabilities. In some embodiments, the printed information may comprise one or more portions of a name, a social security number, an account number, an expiration date, a security code and/or medical information.

If a device comprises more than one identification token, zero, one or more of such identification tokens may comprise a proximity payment device.

The above description and/or the accompanying drawings are not meant to imply a fixed order or sequence of steps for any process referred to herein; rather any process may be performed in any order that is practicable, including but not limited to simultaneous performance of steps indicated as sequential.

The proximity payment cards described herein may be considered to be a sort of contactless smart card. The teachings of this application are thus applicable to contactless smart cards generally, as well as to so-called “dual interface” smart cards, which contain a set of contacts on a surface of the card to allow for direct contact interface to a terminal. “Dual interface” smart cards also include an antenna to allow for interfacing to a terminal by wireless transmission of signals.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method comprising:
providing an integrated circuit (IC) card having a first size and carried as part of a surrounding card having a second size larger than the first size, the IC card including an IC, the surrounding card including an antenna coupled to the IC; and
transmitting to the IC via the antenna an account number for storage in the IC, the account number to be accessed with use of the IC card.

2. The method of claim 1, further comprising:
transmitting to the IC via the antenna a name of a cardholder to whom the IC card is to be sent.

3. The method of claim 1, further comprising:
snapping the IC card out of the surrounding card, thereby detaching the IC from the antenna.

4. The method of claim 3, further comprising:
installing the IC card in a wristwatch, wristband or bracelet to connect the IC to an antenna included in the wristwatch, wristband or bracelet.

5. The method of claim 1 wherein the account number comprises an account number corresponding to a payment card account.

6. The method of claim 5, further comprising:
transmitting to the IC via the antenna a name of a cardholder to whom the IC card is to be sent.

7. The method of claim 5, further comprising:
snapping the IC card out of the surrounding card, thereby detaching the IC from the antenna.

8. The method of claim 7, further comprising:
installing the IC card in a wristwatch, wristband or bracelet to connect the IC to an antenna included in the wristwatch, wristband or bracelet.

9. An identification token comprising:
a carrier having a body;
a card including an RFID integrated circuit;
a bridge joining the card to the carrier;
an antenna; and
an electrically conductive connection running along the bridge, the electrically conductive connection coupling the RFID IC to the antenna.

10. The identification token of claim 9, wherein the card has a first size and the carrier has a second size larger than the first size

11. The identification token of claim 9, wherein the carrier is generally card shaped.

12. The identification token of claim 9, wherein the carrier has dimensions as defined for an ID1 card in ISO/IEC standard 7810.

13. The identification token of claim 9, wherein the card is substantially defined within the body of the carrier.

14. The identification token of claim 9, wherein the card is surrounded by the carrier.

15. The identification token of claim 9, wherein the card has dimensions as defined for a ID000 card/module in ISO/IEC standard 7810.

16. The identification token of claim 9, wherein the bridge comprises a bridge at the periphery of the card and the body of the carrier.

17. The identification token of claim 9, wherein the antenna comprises an antenna embedded in the carrier.

18. The identification token of claim 9, wherein the antenna comprises several loops.

19. The identification token of claim 9, wherein the antenna comprises several loops that run along a periphery of the carrier.

20. The identification token of claim 9, wherein the electrically conductive connection comprises an electrically conductive connection at least partially embedded in the bridge.

21. The identification token of claim 9, wherein the card is substantially defined by punching or scoring.

22. The identification token of claim 9, wherein the card is substantially defined by substantial or nearly complete punching or scoring of the body of the carrier

23. The identification token of claim 9, wherein the RFID IC card stores a payment card account number.

24. The identification token of claim 23, wherein the carrier is generally card shaped, the bridge comprises a bridge at the periphery of the card and the body of the carrier, the antenna comprises an antenna embedded in the carrier, the electrically conductive connection comprises an electrically conductive connection at least partially embedded in the bridge and the card is substantially defined by punching or scoring.

25. A method comprising:
providing a carrier having a body;
providing a card including an RFID integrated circuit;
providing a bridge joining the card to the carrier; and
providing an antenna and an electrically conductive connection running along the bridge, the electrically conductive connection coupling the RFID IC to the antenna.

26. The method of claim 25, further comprising transmitting to the RFID IC via the antenna information for storage in the RFID IC.

27. The method of claim 26, wherein the information comprises a payment card account number.

28. The method of claim 26, further comprising detaching the card from the carrier after transmitting to the RFID IC via the antenna.

29. The method of claim 28, wherein detaching comprises snapping the card from the bridges.

30. The method of claim 26, further comprising installing the card in a device having an antenna.

31. The method of claim 30, wherein the device comprises a wristwatch, wristband or bracelet.

32. A method comprising:
providing an integrated circuit (IC) card attached to a surrounding card, the IC card including an IC, the surrounding card including an antenna coupled to the IC; and
transmitting to the IC via the antenna information for storage in the IC, the information to be accessed with use of the IC card after the IC card is detached from the surrounding card.

33. The method of claim 32 wherein the information comprises an account number.

34. The method of claim 33 wherein the account number comprises an account number corresponding to a payment card account.

35. The method of claim 32, further comprising:
transmitting to the IC via the antenna a name of a cardholder to whom the IC card is to be sent.

36. The method of claim 32, further comprising:
snapping the IC card out of the surrounding card, thereby detaching the IC from the antenna.

37. The method of claim 36, further comprising:
installing the IC card in a wristwatch, wristband or bracelet to connect the IC to an antenna included in the wristwatch, wristband or bracelet.
